(19) United States
(12) Patent Application Publication
(10) Pub. No.: US 2004/0066647 A1
(43) Pub. Date: Apr. 8, 2004

(54) Method of identifying lock key hole and advertising

(76) Inventor: Jovan J. Brady, Woodland Park, CO (US)

Correspondence Address: Glen F. Gallinger, 7420 Milner Dr., #1000, Colorado Springs, CO, 80920, US

(21) Appl. No.: 10/263,307

(22) Filed: Oct. 3, 2002

(51) Int. Cl. E05B 17/10

(52) U.S. Cl. 362/100; 362/34; 362/84; 362/23

(57) ABSTRACT

A method of facilitating opening a lock having a keyhole is disclosed. Most generally the method comprises the steps of providing an illuminant plastic keyhole marker which radiates light after prolonged exposure to light; and, attaching the illuminant plastic marker adjacent to the keyhole of the lock. Then, in reduced lighting conditions the plastic marker will emit light energy to direct a user to the location of the key hole. In a preferred aspect of this apparatus the additional step of providing a cut-out from an inner opening of the plastic keyhole marker is provided to the user for attachment to the key of the lock. This enables the user to readily identify in the dark which of several keys is the correct key for the lock. A method of advertising a business comprising the following steps: stamping advertising information on an illuminant plastic keyhole marker which radiates light after prolonged exposure to light; distributing the illuminant marker to a potential future customer of the business; and, directing the potential customer to attach the keyhole marker adjacent to a keyhole of a lock which they want to more quickly open.

### FIELD OF THE INVENTION

This invention relates to keyed entry locks. More particularly this invention relates to a method of identifying the location of a lock key hole to facilitate quick entry especially in conditions of poor lighting or darkness.

### BACKGROUND OF THE INVENTION

The inventor noticed the need for an inexpensive and consistently reliable method of more quickly accessing a keyhole on a lock in reduced lighting conditions. The lock being opened could be on a door of a dwelling or on a door of a vehicle. The keyhole could alternatively be on an immoveable frame for a door, on a lock having a shackle, or on a suitcase. The inventor, like all of us had fumbled in the dark on many occasions to first find the right key on his key ring, and then to blindly insert what he thought was the correct key into the keyhole. The door on his auto, like many others has multiple scratches, generally centered around the keyhole on the door lock, where the key was once attempted to be inserted. An inexpensive and consistently reliable method of more efficiently accessing a correct key and then inserting the key in its keyhole in the dark is needed.

### OBJECTS OF THE INVENTION

It is an object of this invention to disclose an effective and reliable method of accessing a proper key on a key ring in the dark. It is an object of this invention to disclose an effective and reliable method of directing a key into a keyhole in the dark. It is yet a further object of this invention to disclose a method of reducing the number of scratches on a surface around a keyhole. It is a final object of this invention to disclose a method of advertising which will cost effectively display an advertising message to potential customers repeated times.

One aspect of this invention provides for a method of facilitating opening a lock having a keyhole comprising the steps: providing an illuminant plastic keyhole marker which radiates light after prolonged exposure to light; and, attaching the illuminant plastic marker adjacent to the keyhole of the lock. Then, in reduced lighting conditions the plastic marker will emit light energy to direct the user to the location of the key hole.

In a preferred aspect of this apparatus the additional step of providing a cut-out from an inner opening of the plastic keyhole marker is provided to the user for attachment to the key of the lock. This enables the user to readily identify in the dark which of several keys is the correct key for the lock.

Another aspect of this invention is a method of advertising a business comprising the following steps: stamping advertising information on an illuminant plastic keyhole marker which radiates light after prolonged exposure to light; distributing the illuminant marker to a potential future customer of the business; directing the potential customer to attach the keyhole marker adjacent to a keyhole of a lock which they want to more quickly open. Then, in reduced lighting conditions the customer will be directed to the location of the keyhole, and in more abundant light the customer will be repetitively reminded of the business.

Various other objects, advantages and features of this invention will become apparent to those skilled in the art from the following description in conjunction with the accompanying drawings.

### FIGURES OF THE INVENTION

FIG. 1 is an elevational view of an illuminant plastic keyhole marker positioned around a keyhole on the door of an auto.

FIG. 2 is an enlarged cross sectional view taken along line 2-2 on FIG. 1 of the view of the illuminant keyhole marker having a backer peeled therefrom to expose the marker's adhesive back side portion.

FIG. 3 shows an alternative embodiment of the invention positioned on the lock shown in FIG. 1. In this embodiment the marker is cut in a decorative shape and enlarged to protect the surface around the lock. Advertising information may be printed on the marker.

FIG. 4 is a perspective drawing of a key having the cut-out from the round inner opening attached to the key so that the key can be readily identified when held on a key ring holding several keys.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

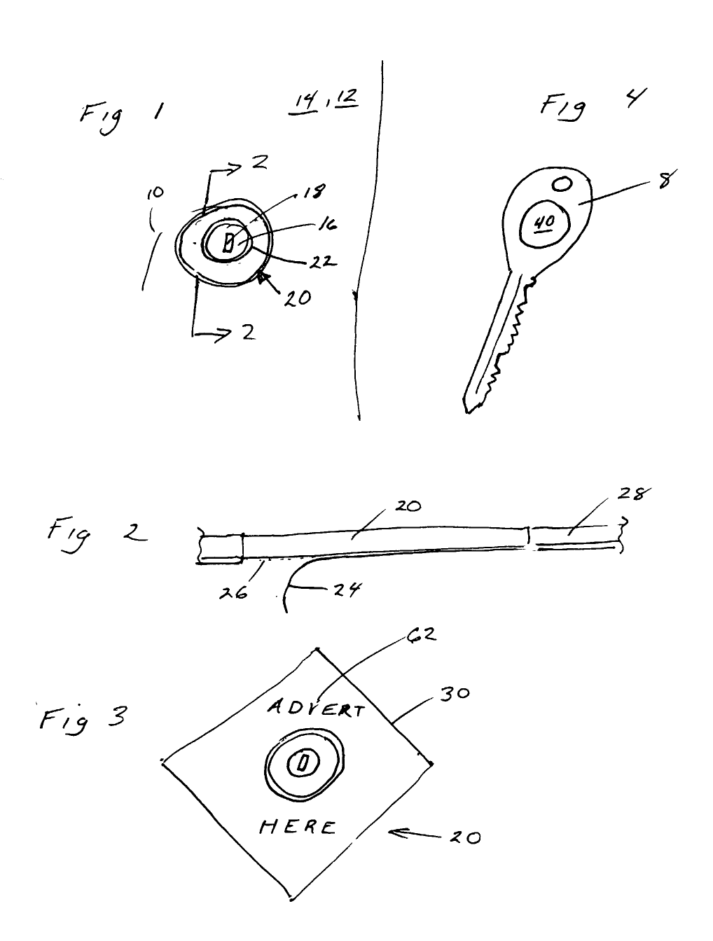

Turning now to the drawings and more particularly to FIG. 1 we have an elevational view of an illuminant plastic keyhole marker 20 positioned around a keyhole 18 in a lock 16 on the door 14 of an auto. Most generally a method of facilitating opening a lock 16 having a keyhole 18 comprises the steps: providing an illuminant plastic keyhole marker 20 which radiates light after prolonged exposure to light; attaching the illuminant plastic marker 20 adjacent to the keyhole 18 of the lock 18. In reduced lighting conditions the plastic marker 20 will emit light energy to direct a user to the location of the key hole 18.

Most preferably, the keyhole marker 20 comprises a generally round inner opening 22 and the step of attaching the marker 20 includes positioning the opening 22 over and around the keyhole 18 so that the targeted keyhole 18 is encircled by light in reduced lighting conditions.

FIG. 2 is an enlarged cross sectional view taken along line 2-2 on FIG. 1 of the view of the illuminant keyhole marker 20 having a backer 24 peeled therefrom to expose the marker's 20 adhesive back side portion 26. Most preferably the plastic marker 20 is made by cutting a sheet 28 of illuminant material having a self adhesive back side portion 26 which can be exposed when a backer 24 is peeled therefrom. In a preferred embodiment the sheet 28 of illuminant material is cut in a functional doughnut like shape (as shown in FIG. 1) so that the keyhole 18 is surrounded by a ring of light of light.

FIG. 3 shows an alternative embodiment of the invention positioned on the lock 16 shown in FIG. 1. In this embodiment the marker 20 is cut in a decorative shape and enlarged to protect the surface 12 around the lock 16. FIG. 3 shows the marker 20 is enlarged relative to the size of the marker 20 shown in FIG. 1 and is cut in a diamond shape 30. The marker 20 is enlarged to protect the surface area 12 around the lock 16 from possible key marks 10.

FIG. 4 is a perspective drawing of a key 8 having the cut-out 40 from the round inner opening 22 attached to the key 8 so that the key 8 can be readily identified when held on a key ring (not shown) holding several keys 8. The step of providing the cut-out 40 from the round inner opening 22 to the user for attachment to the key 8 enables a user to quickly identify which of several keys 8 is the correct key to open the lock 16 in the dark.

A method of advertising a business comprises the following steps: stamping advertising information 62 on an illuminant plastic keyhole marker 20 which radiates light after prolonged exposure to light; distributing the illuminant marker 20 to a potential future customer of the business; directing the potential customer to attach the keyhole marker 20 adjacent to a keyhole 18 of a lock 16 which the customer wants to more quickly open. Then in reduced lighting conditions the customer will be directed to the location of the keyhole 18, and in more abundant light the customer will be repetitively reminded of the business. In this specification stamping is intended to include any type of printing advertising information 62 on the keyhole marker 20 such as simply rubber stamping with ink or alternatively imbedding such message 62 into the keyhole marker 20.

While the invention has been described with preferred specific embodiments thereof, it will be understood that this description is intended to illustrate and not to limit the scope of the invention, which is defined by the following claims.

I claim:

1) A method of facilitating opening a lock having a keyhole comprising the steps:
providing an illuminant plastic keyhole marker which radiates light after prolonged exposure to light;
attaching the illuminant plastic marker adjacent to the keyhole of the lock;
so that in reduced lighting conditions the plastic marker will emit light energy to direct a user to the location of the key hole.

2) A method as in claim 1 wherein the keyhole marker comprises a generally round inner opening and wherein the step of attaching the marker includes positioning the opening over and around the keyhole so that the targeted keyhole is encircled by light in reduced lighting conditions.

3) A method as in claim 1 wherein the plastic marker is made by cutting a sheet of illuminant material having a self adhesive back side portion which can be exposed when a backer is peeled therefrom.

4) A method as in claim 3 wherein the sheet of illuminant material is cut in a functional doughnut like shape so that the keyhole is surrounded by a ring of light of light.

5) A method as in claim 3 wherein the illuminant material is cut in a decorative shape.

6) A method as in claim 3 further comprising the step of providing the cut-out from the round inner opening to the user for attachment to the key of the lock to enable the user to readily identify in the dark which of several keys is the correct key for the lock.

7) A method as in claim 3 wherein the illuminant material covers a substantially enlarged area around the keyhole to protect an enlarged surface area from possible key marks.

8) A method of advertising a business comprising the following steps:
stamping advertising information on an illuminant plastic keyhole marker which radiates light after prolonged exposure to light;
distributing the illuminant marker to a potential future customer of the business;
directing the potential customer to attach the keyhole marker adjacent to a keyhole of a lock which they want to more quickly open;
so that in reduced lighting conditions the customer will be directed to the location of the keyhole, and in more abundant light the customer will be repetitively reminded of the business.

9) A method as in 8 wherein the wherein the keyhole marker comprises a generally round inner opening and wherein the step of directing the attachment of the marker includes positioning the opening over and around the keyhole so that the targeted keyhole is encircled by light in reduced lighting conditions.

10) A method as in claim 8 wherein the plastic marker is made by cutting a sheet of illuminant material having a self adhesive back side portion which can be exposed when a backer is peeled therefrom.

11) A method as in claim 10 wherein the illuminant material is cut in a functional doughnut like shape so that the keyhole has is surrounded by a ring of light.

12) A method as in claim 10 wherein the sheet of illuminant material is cut in a decorative shape.

13) A method as in claim 12 further comprising the step of providing the cut-out from the round inner opening to the user for attachment to the key of the lock to enable the user to readily identify in the dark which of several keys is the correct key for the lock.

14) A method as in claim 10 wherein the illuminant material covers a substantially enlarged area around the keyhole to protect an enlarged surface area from possible key marks.
